(19) United States
(12) Patent Application Publication
(10) Pub. No.: US 2026/0216678 A1
(43) Pub. Date: Jul. 30, 2026

(54) Vacuum Catalytic Pyrolysis System and Method for Converting Waste Polymers into Multi-Grade Transportation Fuels Using Nanocomposite Catalyst Cartridges and AI-Based Process Control

(71) Applicant: Sunyoung Kim, Los Angeles, CA (US)

(72) Inventor: Sunyoung Kim, Los Angeles, CA (US)

(21) Appl. No.: 19/639,205

(22) Filed: Apr. 4, 2026

(51) Int. Cl. B01J 8/06; C10G 1/10

(52) U.S. Cl. CPC B01J 8/067; C10G 1/10; B01J 2208/00389; B01J 2208/00539; B01J 2208/065; C10G 2300/1003; C10G 2300/202; C10G 2300/4012; C10G 2300/70

(57) ABSTRACT

An integrated vacuum catalytic pyrolysis platform converts hydrocarbon waste into ULSD-grade multi-grade fuels at 15-120 Torr using a single vacuum pump as the sole driving force. The platform features selectable multi-mode vertical reactor isolation (dual-airlock, knife gate valve, or hybrid) scalable from pilot (7.5 m, five stages) to commercial (14 m, four stages) configurations, configurable horizontal reactor thermal management (multi-component achieving unexpectedly low thermal gradient under vacuum, dual-mode, or triple-mode), multi-layer nanocomposite catalyst with FIR emissive layer (including HEO option with self-regenerating noble metal nanoparticles), inline capillary-condensation desulfurization overcoming six Teaching Away references, physics-constrained neural network control with non-trainable hard-constraint layers optionally augmented by vision-based vapor monitoring, cyclone-type separators for continuous particulate and droplet removal without consumable media, and dual-medium staged condensation with boiling-range-classified product collection for direct multi-grade fuel segregation. Thirty claims differentiated over 31+ prior art references with 19 supporting examples.

### CROSS-REFERENCE TO RELATED APPLICATIONS

Not Applicable.

### STATEMENT REGARDING FEDERALLY SPONSORED RESEARCH OR DEVELOPMENT

Not Applicable.

### STATEMENT REGARDING PRIOR DISCLOSURES BY THE INVENTOR OR A JOINT INVENTOR

Not Applicable.

### FIELD OF THE INVENTION

The present invention relates generally to the field of waste-to-fuel conversion, and more particularly to an integrated vacuum catalytic pyrolysis platform that converts hydrocarbon-containing waste feedstocks into multi-grade liquid transportation fuels under sub-atmospheric conditions using a single vacuum pump as the sole mechanical driving force for the entire series-connected process train.

### BACKGROUND OF THE INVENTION

Prior Art Group 1—Vacuum Pyrolysis Limitations: Existing vacuum pyrolysis systems suffer from one or more of the following deficiencies: (a) vacuum applied only after cracking is complete (CN114423803A, WO2020242914A1), providing no in-situ boiling point depression during the cracking reaction itself; (b) operation below 35 Torr requiring expensive multi-stage vacuum pumps (U.S. Pat. No. 4,740,270A, Roy 1988); (c) vacuum operation without catalysis or series-connected downstream processing (EP0588814B1, Roy/Laval 1993); (d) atmospheric-pressure operation providing no vacuum benefit whatsoever (US20240002735A1, EP4541869A1, KR102771359B1, CN114746531A); or (e) ultra-high vacuum (10\hat{ }−9 to 10\hat{ }−12 Torr) for polymer devolatilization only, six or more orders of magnitude different from catalytic pyrolysis conditions (EP3491102A1/U.S. Pat. No. 10,829,696B2). No prior art reference, alone or in combination, teaches a single-pump sub-atmospheric catalytic series train operating at 15 to 120 Torr with in-situ Clausius-Clapeyron boiling point depression quantified across three distinct feedstock-adaptive sub-ranges.

Prior Art Group 2—Reactor Thermal Management: Roy et al. (1997, Developments in Thermochemical Biomass Conversion) established that vacuum pyrolysis reactors suffer from severely degraded wall-to-center heat transfer coefficients (HTC) of only 10-60 W/m2−K, compared to atmospheric reactors achieving 200+ W/m2−K. Existing solutions (U.S. Pat. No. 10,160,920; WO2019/078756; KR20230010199A) all operate at atmospheric pressure and do not address vacuum-specific thermal degradation. No prior reference teaches a configurable multi-mode thermal compensation system capable of recovering vacuum HTC to 85-95% of atmospheric level, and no reference discloses or suggests achieving a wall-center temperature gradient under vacuum that is smaller than the corresponding atmospheric baseline gradient.

Prior Art Group 3—Desulfurization Teaching Away: U.S. Pat. No. 4,524,050A (Air Products, 1985) constitutes the strongest Teaching Away reference, explicitly stating that sub-atmospheric pressure provides insufficient water vapor partial pressure for catalytic COS hydrolysis. Five additional independent references (EP0145372B1/JPS60123435A spanning three jurisdictions; U.S. Pat. No. 6,843,907B1; EP3738669A1; ACS I&EC Research 2022; ACS Energy & Fuels 2021) all teach COS hydrolysis exclusively at atmospheric or super-atmospheric conditions. No prior reference teaches or suggests overcoming this Teaching Away through mesopore capillary condensation within the desulfurization catalyst bed itself.

Prior Art Group 4—Catalyst Technology: EP2324914B1 (Sakai Chemical) discloses binary TiO2-ZrO2 for atmospheric pyrolysis. US20230226527A1 (Sandia National Labs) discloses high-entropy oxide (HEO) for atmospheric CO oxidation. Neither reference teaches a multi-layer catalyst pellet incorporating an HEO far-infrared (FIR) emissive layer as an integral functional component providing simultaneous catalytic and radiative heat transfer functions within a vacuum pyrolysis reactor.

Prior Art Group 5—AI/ML Control: GB2599837A (2022) discloses generative ML for reactor control. Tarkhov et al. (Sci. Rep. 2023) describes theoretical PBA-PINN architecture. Ex parte Desjardins (PTAB 2025.11.04, PRECEDENTIAL) established three pathways for AI/ML patent eligibility under 35 U.S.C. § 101. No prior reference teaches a physics-constrained neural network with non-trainable structural hard-constraint layers (as distinguished from soft penalty terms) directly driving physical hardware actuators within a guaranteed sub-second control cycle.

Prior Art Group 6—Vertical Reactor Isolation: Miranda et al. (2001) teaches 15 Torr batch-mode pyrolysis without continuous multi-stage operation. AU2005339271A1 discloses dual knife gate valves in a single-stage system. U.S. Pat. No. 9,365,775B1 teaches single-stage airlock. U.S. Pat. No. 10,208,253B2 teaches radial blade agitation in single-stage non-vacuum systems. No reference teaches a continuous multi-stage vertical vacuum reactor with selectable isolation configurations providing different cost-performance tradeoffs at sub-atmospheric pressure.

KSR Integrated Non-Obviousness: None of the 31+ references cited herein, alone or in any combination suggested by the prior art, discloses the synergistic combination of all elements recited in the independent claims. The unexpected results documented in the Examples (particularly the paradoxical thermal gradient result of Example 7 and the critical pressure window of Example 6) confirm that the claimed combinations are not merely aggregations of known elements but produce synergistic and unpredictable results. See KSR International Co. v. Teleflex Inc., 550 U.S. 398 (2007).

### BRIEF SUMMARY OF THE INVENTION

In a first aspect, the invention provides an integrated vacuum catalytic pyrolysis platform in which a single vacuum pump positioned at the downstream end of a series-connected process train serves as the sole mechanical driving force, maintaining a sub-atmospheric operating pressure across the entire process train without intermediate repressurization. The operating pressure range encompasses a plurality of selectable sub-ranges adapted to different feedstock characteristics.

In a second aspect, the invention provides a multi-stage vertical reactor R-101 having a selectable isolation system chosen from at least three configurations offering different vacuum leakage characteristics and capital cost tradeoffs, wherein the selection is made based on the target feedstock and economic constraints of a particular installation.

In a third aspect, the invention provides a configurable horizontal reactor system having a selectable thermal management system chosen from at least three configurations offering different thermal gradient performance levels, each configuration being optimized for a different balance of capital cost and thermal uniformity.

In a fourth aspect, the invention provides a multi-layer nanocomposite catalyst pellet housed within a detachable perforated cage, the pellet having a far-infrared emissive functional layer that simultaneously provides catalytic activity and radiative heat transfer contribution within the vacuum reactor.

In a fifth aspect, the invention provides an inline desulfurization module that achieves COS hydrolysis under sub-atmospheric conditions by exploiting capillary condensation within catalyst mesopores, thereby overcoming the established Teaching Away of the prior art.

In a sixth aspect, the invention provides a physics-constrained neural network control system having non-trainable structural constraint layers that enforce thermodynamic laws as hard architectural constraints rather than soft penalty terms, with guaranteed sub-second hardware actuation response.

### BRIEF DESCRIPTION OF THE SEVERAL VIEWS OF THE DRAWING

FIG. 1 is a process flow diagram of the integrated platform showing five process zones (Zone 100 through Zone 500), multi-stage vertical reactor R-101, and the single vacuum pump VP-201 driving force at 15 to 120 Torr.

FIG. 2 is an elevation view of the multi-stage vertical reactor R-101 showing five reaction stages S1 through S5 with rotary valve and gate valve isolation at each stage boundary, representing one of the three selectable isolation configurations described herein.

FIG. 2A is a cross-sectional detail of a single reaction stage showing screw agitator M-101, radial blade agitation elements, and rotary valve/gate valve isolation mechanisms.

FIG. 3 is a schematic of the parallel pre-reactor configuration showing four pre-reactors PR-01A through PR-01D converging at a common vapor header upstream of main reactor R-201.

FIG. 3A is a schematic of the series reactor configuration showing four reactors R-201 through R-204 at progressively increasing temperatures with configurable thermal management.

FIG. 4 is an exploded view of the catalyst cartridge CC-630 showing the enclosed perforated cage, snap-fit bracket, and five-layer coin pellet cross-section with layers L1 through L5.

FIG. 5 is a schematic of the four-stage inline desulfurization module showing GB-301 (HDM guard bed), R-302 (COS hydrolysis), R-303 (HDS), and GB-304 (ZnO guard bed) with capillary condensation mechanism detail and Kelvin equation.

FIG. 6 is a schematic of the three-stage dechlorination system showing calcium hydroxide vacuum stripping, alkali catalyst neutralization, and sodium hydroxide wet scrubbing stages.

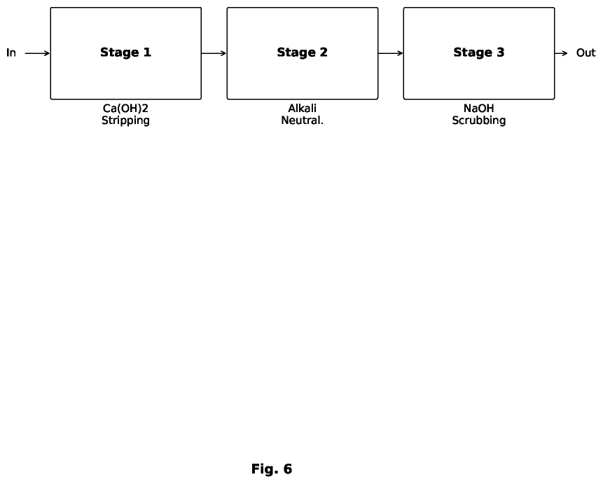

FIG. 7 is a schematic of the multi-column separation cascade showing pressure-gradient mode with columns C-201, C-202, and C-203, and closed-loop reflux circuit with reflux reactor R-202.

FIG. 8 is a cross-sectional view of the five-layer coin pellet showing concentric layers L1 through L5, with Option A (ternary oxide) and Option B (high-entropy oxide) for the FIR emissive layer L3.

FIG. 9 is an architecture diagram of the PBA-PINN hard-constraint neural network showing input layer receiving signals from a plurality of process sensors (including at least pressure P, temperature T1 through T5, flow F, vacuum V, pH, and optionally sight glass SG sensors), three hidden layers (128 nodes each), hard-constraint layer (Clausius-Clapeyron and Arrhenius equations), and output layer driving a plurality of hardware actuators (including at least electric heater EH, vacuum pump VP, pressure control valve PCV, and flow control valve FCV) with guaranteed 500 ms total cycle time.

FIG. 10 is a cross-sectional view of the horizontal reactor showing multi-component thermal compensation: vacuum jacket VJ, heated oil duct, electric heaters EH, and CC-630 catalyst cage, achieving a wall-center temperature gradient of 8 degrees C. under vacuum.

FIG. 11 is a graph of boiling point versus carbon number at 760, 90, and 70 Torr showing Clausius-Clapeyron depression of 107 degrees C. for C20 hydrocarbons at 70 Torr.

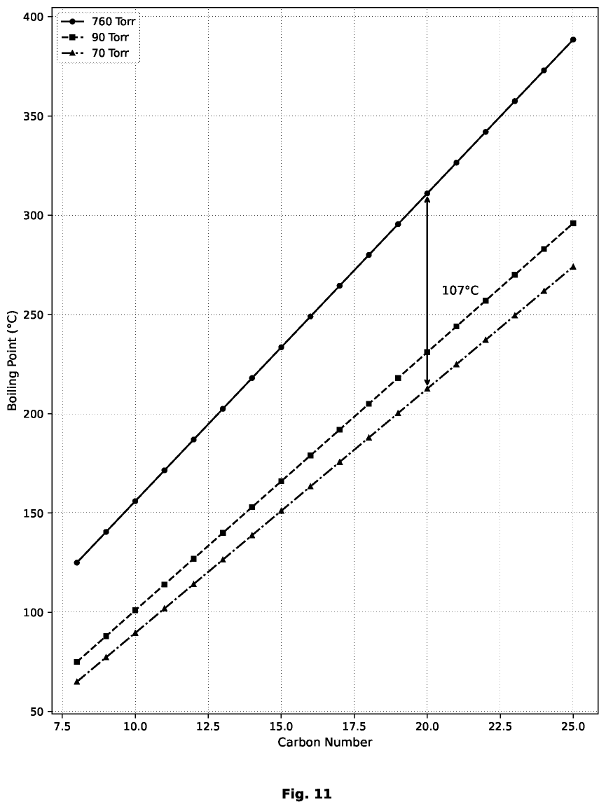

FIG. 12 is a sequence diagram showing the four-step tool-free catalyst cartridge exchange procedure: pellet loading, cage insertion, snap-fit engagement, and contact verification.

FIG. 13 is an extended process flow diagram showing both parallel (Path A: PR-01A through PR-01D) and series (Path B: R-201 through R-204) processing paths converging to common separation, desulfurization, and vacuum sections.

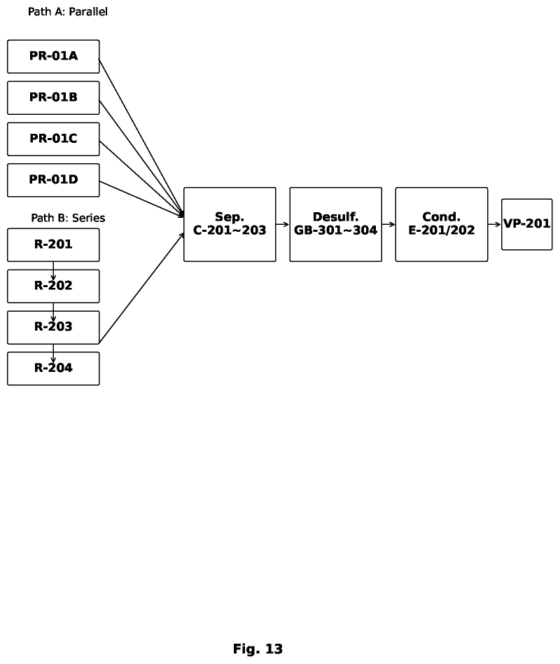

FIG. 14 is a detail diagram of the capillary condensation mechanism within mesopores of the desulfurization catalyst, showing the Kelvin equation relationship and localized water vapor partial pressure enhancement.

FIG. 15 comprises (a) a unit cell diagram of the high-entropy oxide fluorite crystal structure showing five metal cation species (Ti, Zr, Ce, Hf, Y) and oxygen positions, and (b) a graph comparing FIR emissivity of Option A (ternary oxide, emissivity 0.90 or greater) and Option B (high-entropy oxide, emissivity 0.95 or greater) across wavelengths of 4 to 14 micrometers.

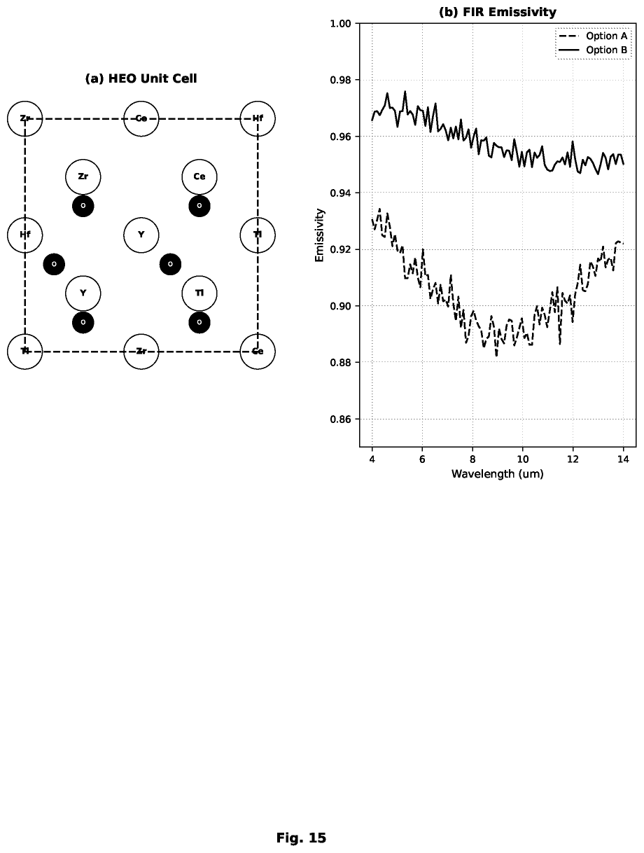

FIG. 16 is a block diagram of the smart cartridge digital twin system showing the physical CC-630 cartridge with RFID/NFC sensor, edge controller, PBA-PINN digital twin predictive model, remaining useful life (RUL) estimation module, and HMI/SCADA display.

FIG. 17 is a detail of the condensation and vacuum section (Zone 400-500) showing shell-and-tube condenser E-201 with aqueous-medium cooling, secondary condenser E-202 with hydrocarbon-medium cooling, oil collection drums D-202A/B, water separation drum D-203, cyclone-type pre-separators F-201, cyclone-type product separators F-202, vacuum pump VP-201, activated carbon adsorber AD-201, and chiller CH-201.

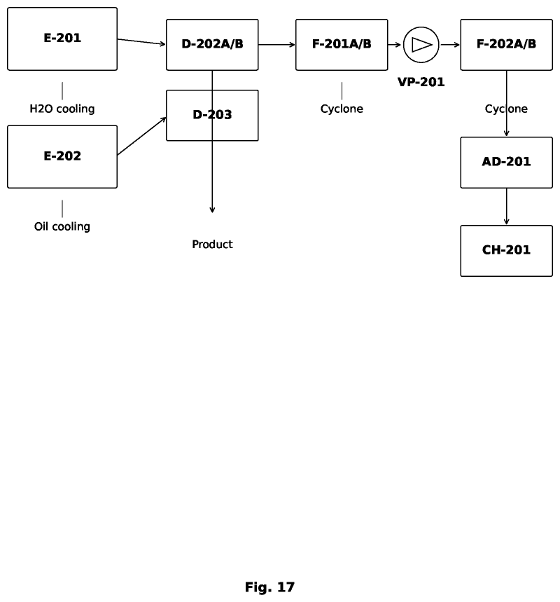

FIG. 18 is an alternative detail of the condensation and vacuum section showing a boiling-range-classified product collection arrangement comprising heavy oil collection drums D-204A/B for collecting condensed high-boiling-point fractions and a light oil collection drum D-205 for collecting condensed low-boiling-point fractions, replacing the single-grade oil collection arrangement of FIG. 17, with cyclone-type separators F-201 and F-202 positioned upstream and downstream of vacuum pump VP-201 respectively.

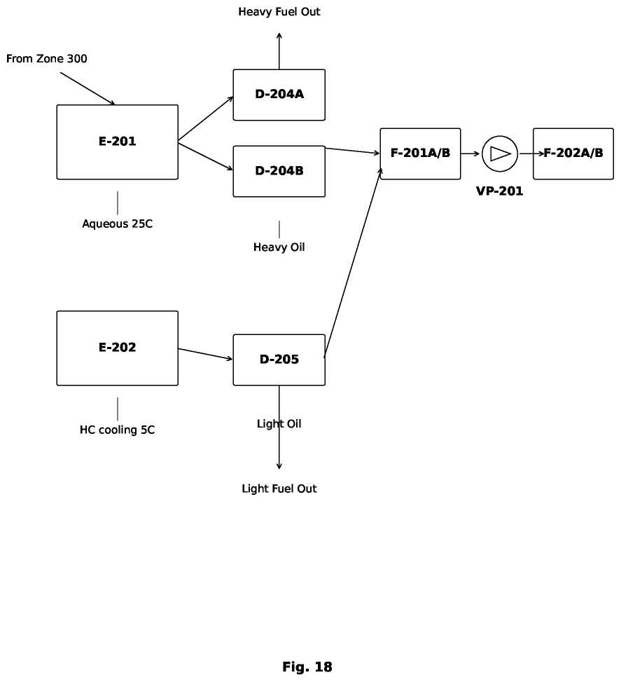

FIG. 19 is a detail view of an in-line sight glass SG-201 installed at an inter-stage vapor transfer line between two process zones, optionally equipped with an imaging sensor for automated vapor flow monitoring integrated with the PBA-PINN control system of FIG. 9.

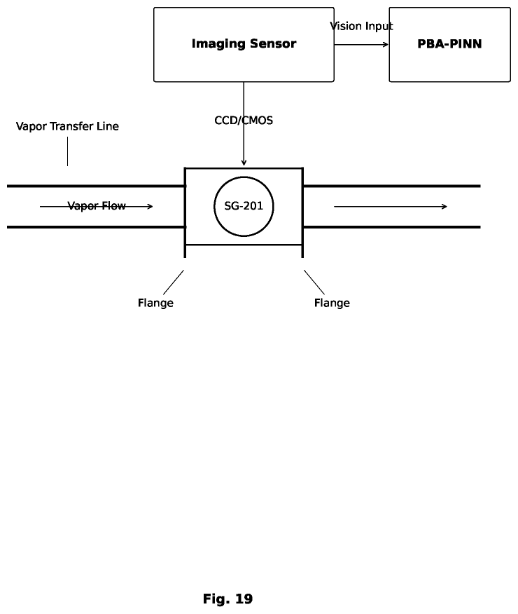

### DETAILED DESCRIPTION OF THE INVENTION

The following detailed description sets forth preferred embodiments of the invention. These embodiments are illustrative and not limiting; the scope of the invention is defined by the appended claims. Specific numerical values, material designations, equipment tag numbers, and dimensional specifications recited below describe preferred embodiments and should not be construed as limiting the claims unless expressly recited therein.

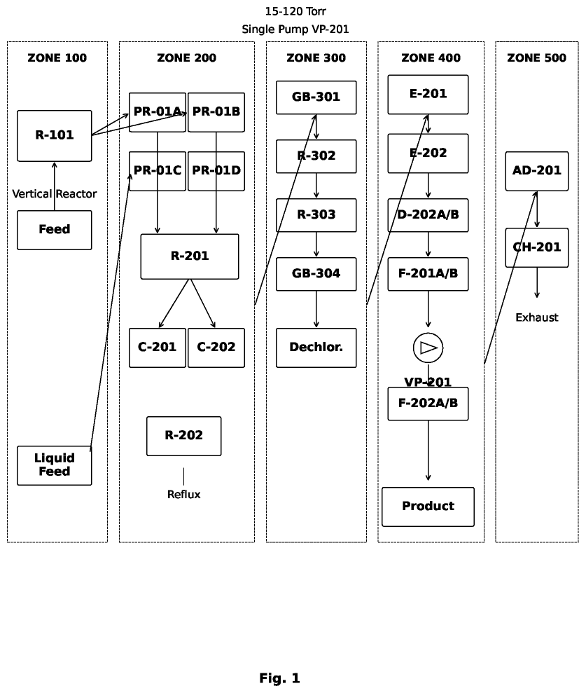

### A. System Overview (FIG. 1)

Referring to FIG. 1, the integrated vacuum catalytic pyrolysis platform 100 comprises five process zones interconnected in series. A single vacuum pump VP-201 positioned at the downstream end of the process train constitutes the sole mechanical driving force for the entire platform, maintaining sub-atmospheric pressure across all zones without intermediate repressurization stages. In a preferred embodiment, VP-201 is a dry screw type vacuum pump having a displacement capacity of approximately 1,500 liters per minute and consuming approximately 4.7 kW, constructed of stainless steel. However, the invention is not limited to dry screw pumps; any vacuum pump type (roots, claw, scroll, or liquid ring) capable of maintaining the specified sub-atmospheric pressure range across the entire series train may be employed.

The operating pressure range of 15 to 120 Torr encompasses three selectable sub-ranges adapted to different feedstock characteristics:
Sub-Range A (15 to 45 Torr): Provides enhanced Clausius-Clapeyron boiling point depression exceeding 120 deg C. for C20 hydrocarbons. Particularly suitable for high-wax content feedstocks such as waste lubricating oil and high-paraffin plastics. Higher pump displacement capacity is required.
Sub-Range B (50 to 90 Torr): Provides optimal balance between liquid yield and pump economics. Maximum observed yield of 92.5% with closed-loop reflux (Example 1). This sub-range defines a critical pressure window: operation above 120 Torr produces dramatically increased wax formation (Example 6 : +340% wax at 120 Torr vs. 70 Torr).
Sub-Range C (91 to 120 Torr): Suitable for low-wax feedstocks with reduced pump capacity requirements.

The five process zones are:
Zone 100—Feed/Pretreatment: Feed handling, solid waste input to vertical multi-stage reactor R-101, liquid waste input to horizontal reactor section.
Zone 200—Liquid Reaction: Main horizontal reactors (parallel or series configuration), separation columns, reflux reactor, centrifugal pump for reflux circulation.
Zone 300—Purification/Desulfurization: HDM guard bed, COS hydrolysis reactor, HDS reactor, ZnO polishing guard bed, dechlorination stages.
Zone 400—Condensation/Vacuum: Shell-and-tube condenser with aqueous-medium cooling, secondary condenser with hydrocarbon-medium cooling, product collection drums (in a first arrangement, single-grade drums with separate water separation; in an alternative arrangement, boiling-range-classified heavy oil and light oil drums), cyclone-type pre-separators, vacuum pump, cyclone-type product separators.
Zone 500—Exhaust Treatment: Activated carbon adsorber, chiller, off-gas treatment.

Process piping specifications in a preferred embodiment: Main vapor lines nominally 100 A stainless steel; exhaust lines nominally 40 A; reflux lines nominally 25 A; vacuum suction connection with reducing coupling from nominally 50 A to 40 A. These nominal sizes are illustrative of one preferred installation and may be scaled according to throughput requirements. Optionally, one or more in-line sight glasses (SG-201, SG-202, or additional units) are installed at inter-stage vapor transfer lines to enable visual or automated monitoring of vapor flow characteristics, condensation state, and potential fouling indicators. In a further embodiment, each sight glass location is equipped with an imaging sensor (such as a CCD or CMOS camera with appropriate thermal protection) whose output is fed as an additional input channel to the PBA-PINN control system described herein, enabling vision-based process monitoring in addition to conventional pressure, temperature, and flow sensors.

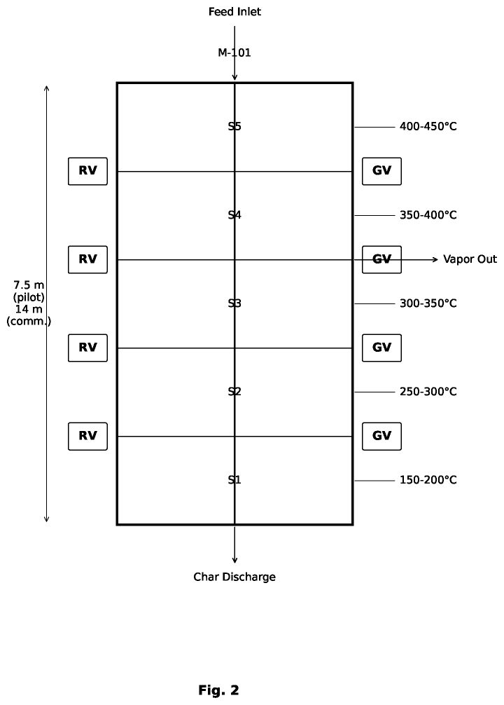

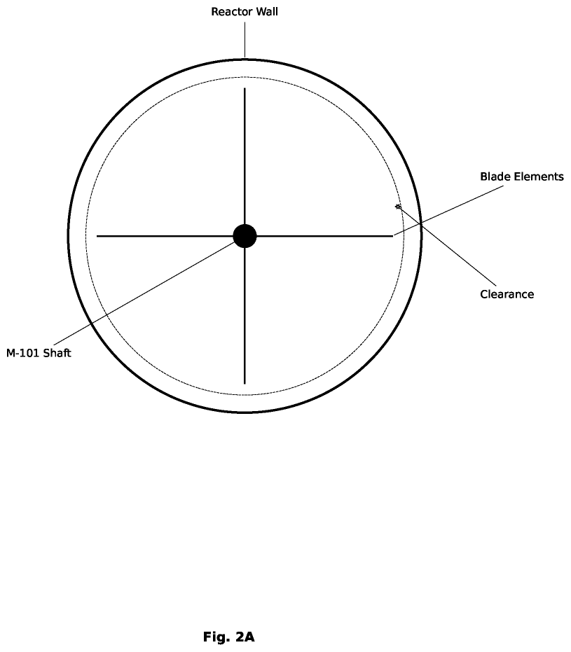

### B. Multi-Stage Vertical Reactor With Selectable Isolation (FIGS. 2, 2A)

The multi-stage vertical reactor R-101 comprises a plurality of vertically stacked reaction stages, each operable at a different temperature within a thermal decomposition range mapped by thermogravimetric analysis (TGA) and, optionally, simulated distillation (ASTM D2887 or equivalent) of the target feedstock. In a preferred embodiment, five stages are provided at approximately 150-200, 250-300, 300-350, 350-400, and 400-450 deg C. However, the number of stages is not limited to five; three, four, six, seven, or more stages may be employed depending on feedstock complexity and desired product fractionation resolution. The stage temperatures are individually controllable and are not limited to the specific ranges of the preferred embodiment.

The total reactor height is determined by the number of stages and per-stage volume required for the target throughput. In one preferred embodiment designed for a pilot-scale throughput, the total reactor height including support structure is approximately 7.5 meters. Commercial-scale embodiments may have significantly different total heights. The invention is defined by the functional characteristics of the multi-stage vacuum reactor with selectable isolation, not by any particular absolute dimension. In a further embodiment scaled for commercial throughput, the vertical reactor has an internal diameter of approximately 800 mm and a total height of approximately 14 meters accommodating four reaction stages, each stage having a reactor body length of approximately 2,000 mm. This commercial-scale embodiment demonstrates that the selectable isolation and multi-stage features of the invention are scalable across different stage counts (three to ten stages as recited in claim 8) and reactor dimensions without departing from the scope of the invention.

The reactor isolation system is selectable from at least three configurations, each offering a different tradeoff between vacuum sealing performance, capital cost, and mechanical complexity:
Configuration (a)—Dual-Airlock: A rotary valve and a gate valve operating in coordination at each stage boundary. The dual-valve arrangement limits vacuum leakage to within approximately plus or minus 2% of the compartment operating pressure. PLC-coordinated actuation timing. Highest vacuum integrity; highest capital cost.
Configuration (b)—Knife Gate Valve: Automatic knife gate valves positioned at least at the feed inlet above the uppermost stage and at the char discharge below the lowermost stage. Pneumatic actuation with elastomeric soft-seal packing (such as PTFE, VITON, or equivalent fluoroelastomer). Vacuum leakage below approximately 5% of operating pressure. Adjacent stages may be connected by flanged connections without intermediate isolation valves. Capital cost approximately 40 to 60 percent lower than Configuration (a).
Configuration (c)—Hybrid: A rotary valve combined with a knife gate valve at each stage boundary. Vacuum leakage within approximately plus or minus 3%. Intermediate cost and performance.

The knife gate valve nominal size is selected based on the reactor internal diameter and feedstock throughput requirements. In a preferred pilot-scale embodiment, a nominal size of approximately DN250 (250 A) is employed. Commercial-scale embodiments may employ larger or smaller valve sizes as dictated by throughput and reactor geometry. The claims are not limited to any particular valve nominal size.

Agitation within the reactor stages is provided by one or more of the following selectable options:
Option (i): A screw agitator in the uppermost stage, achieving a heat transfer coefficient of 200 to 400 W/m2−K, representing a 4 to 40 times improvement over the vacuum baseline of 10 to 60 W/m2−K established by Roy et al. (1997).
Option (ii): Radial blade elements on independent horizontal shafts in at least two stages, each blade assembly having a plurality of blades at equal angular intervals with a controlled clearance from the reactor inner wall.
Option (iii): A combination of radial blades in upper stages and a differentiated mixing structure in the lowermost stage optimized for char handling at elevated temperatures.

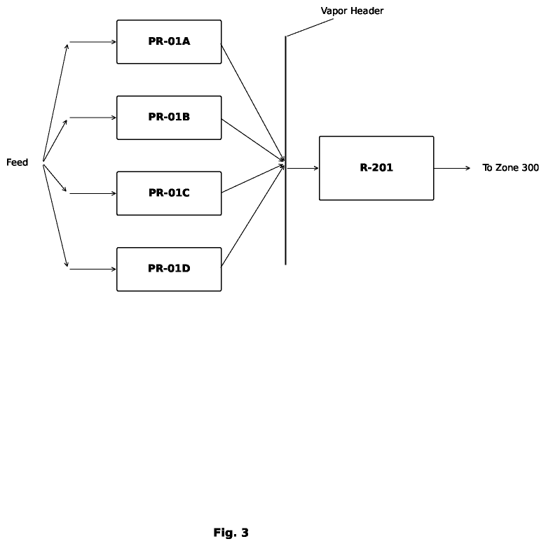

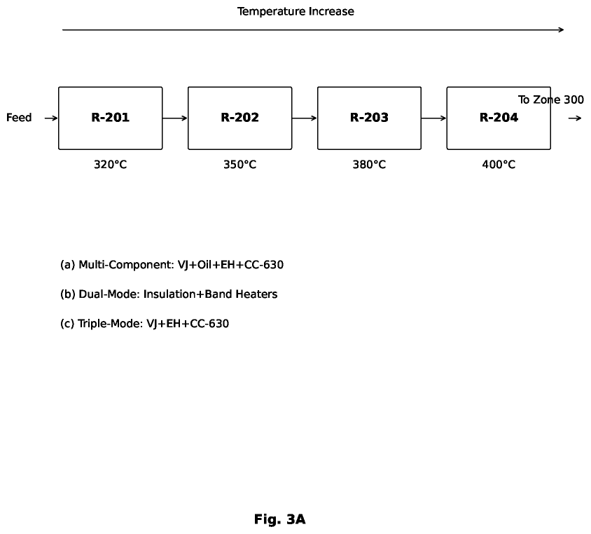

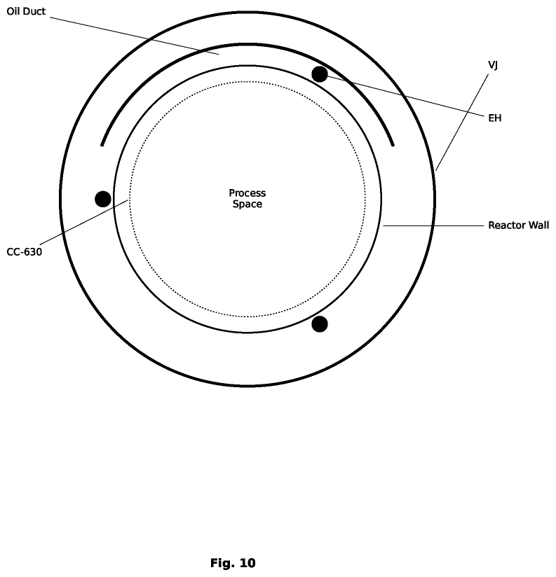

### C. Horizontal Reactors With Configurable Thermal Management (FIGS. 3, 3A, 10)

The horizontal reactor section may be configured as either parallel pre-reactors (allowing individual offline capability) or series-connected reactors at progressively increasing temperatures. Each horizontal reactor operates at 15 to 120 Torr with a selectable thermal management system:
Configuration (a)—Multi-Component: A combination of four thermal compensation elements working in concert: (i) a vacuum insulation jacket; (ii) a heated fluid conduit providing supplemental heat at a temperature above the reactor setpoint, covering a substantial portion of the inner wall area; (iii) one or more electric heating elements coupled to a neural network controller with sub-second response capability; and (iv) an enclosed perforated metal cage containing catalyst pellets having a far-infrared emissive layer, the cage being press-fitted against the reactor inner wall with substantial cage-to-wall contact area, providing conductive-radiative thermal contribution. The combination of all four elements recovers HTC to 85 to 95 percent of atmospheric level, achieving a wall-center temperature gradient of 8 deg C. or less under vacuum—which is unexpectedly and paradoxically smaller than the 15 deg C. gradient measured at atmospheric pressure without vacuum insulation (Example 7).
Configuration (b)—Dual-Mode: A combination of two thermal compensation elements: (i) a fibrous insulation jacket (such as glass fiber, ceramic fiber, or equivalent thermal insulation) surrounding the reactor shell with a thermal resistance value (R-value) of at least 2.0; and (ii) a plurality of independently controlled band-type electric heaters distributed along the reactor length for zone heating, each heater having individual PID temperature control. This configuration does not employ a vacuum insulation jacket, heated fluid conduit, or catalyst cage—constituting a negative limitation distinguishing it from Configuration (a). Wall-center gradient of 15 deg C. or less.
Configuration (c)—Triple-Mode: Vacuum insulation jacket plus band-type heaters plus catalyst cage, without heated fluid conduit. Wall-center gradient of 12 deg C. or less.

In a preferred pilot-scale embodiment, the main horizontal reactor has an internal diameter of approximately 500 to 800 mm and a wall thickness of approximately 5 to 8 mm, constructed of austenitic stainless steel. The dual-mode configuration employs seven band-type heaters. Commercial-scale embodiments may employ different reactor dimensions and heater quantities as required by throughput and thermal modeling.

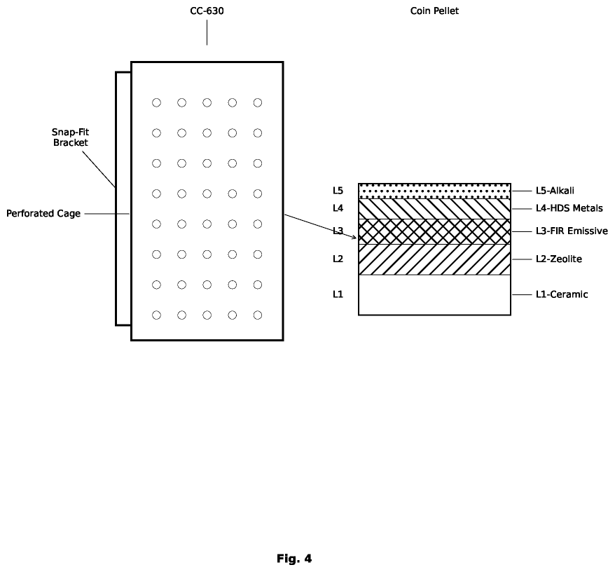

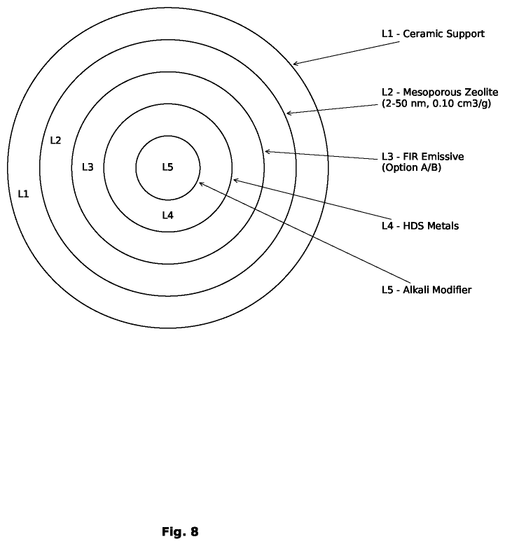

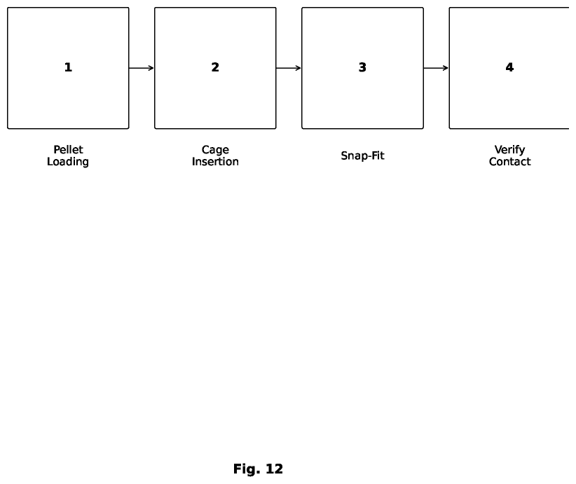

### D. Multi-Layer Nanocomposite Catalyst Cartridge (FIGS. 4, 8, 12)

The catalyst cartridge comprises an enclosed perforated metal cage constructed of a high-temperature alloy (such as Inconel 625, Inconel 718, Hastelloy X, AISI 310, or equivalent alloy having oxidation resistance at the operating temperature). The cage is configured for snap-fit engagement with the reactor inner wall, establishing interfacial thermal conductance of 500 to 2,000 W/m2−K through controlled thermal expansion clearance, with cage external surface contact area of 60 to 85 percent. Tool-free exchange of the entire cartridge is achievable in less than approximately one minute per tray.

The catalyst is provided as multi-layer pellets, each pellet having at least the following functional layers:
Layer 1 (L1)—Structural Support: A ceramic support material providing mechanical integrity, constituting the majority of pellet weight.
Layer 2 (L2)—Hierarchical Mesoporous Cracking Layer: A zeolite-based material (such as USY, ZSM-5, Beta, or combinations thereof) having engineered intracrystalline mesopores in the range of 2 to 50 nm in addition to native micropores, the mesopore volume being at least 0.10 cm3/g, providing enhanced C20+ hydrocarbon conversion relative to a purely microporous control (Example 10: 51.2% improvement).
Layer 3 (L3)—Far-Infrared Emissive Layer: A metal oxide composition having FIR emissivity of at least 0.90 at wavelengths of 4 to 14 micrometers, selected from:
Option A: A ternary or higher-order oxide comprising at least titanium oxide, zirconium oxide, and cerium oxide; or
Option B: A high-entropy oxide (HEO) comprising at least five metal cations (such as Ti, Zr, Ce, Hf, and Y, or substitutional equivalents thereof) forming a single-phase fluorite structure confirmed by X-ray diffraction, having FIR emissivity of at least 0.95 and oxygen storage capacity of at least three times that of pure cerium oxide. Optionally, the HEO incorporates dispersed noble metal nanoparticles (such as Pd at 0.1 to 1.0 wt %) capable of self-regeneration through reversible exsolution-reincorporation cycling.
Layer 4 (L4)—Hydrodesulfurization Metals: Catalytically active metals for sulfur removal.
Layer 5 (L5)—Alkali Modifier: Alkaline earth or alkali metal oxide modifier for acid-base tuning.

The pellet geometry is not limited to any particular shape. In a preferred embodiment, coin-type pellets (flat disc shape) having a diameter of approximately 26 to 30 mm and thickness of approximately 3 to 5 mm are employed. However, alternative pellet geometries including but not limited to spherical, cylindrical, ring-shaped (Raschig ring), saddle-shaped (Berl saddle), trilobal, or quadrilobal shapes may be employed without departing from the scope of the invention, provided the multi-layer functional structure is maintained.

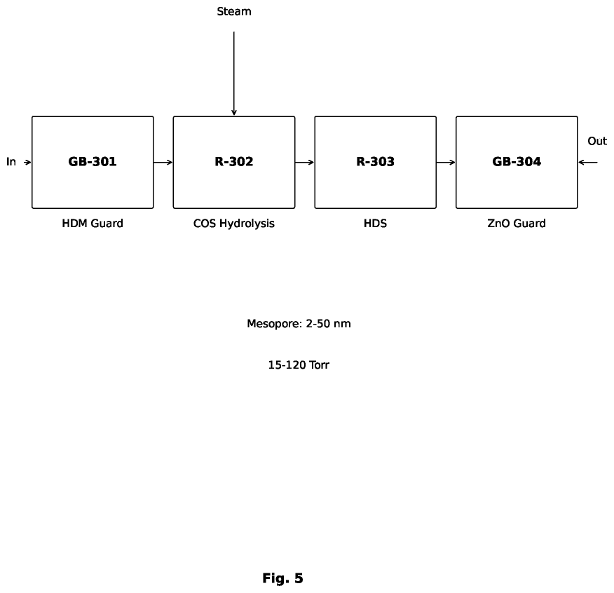

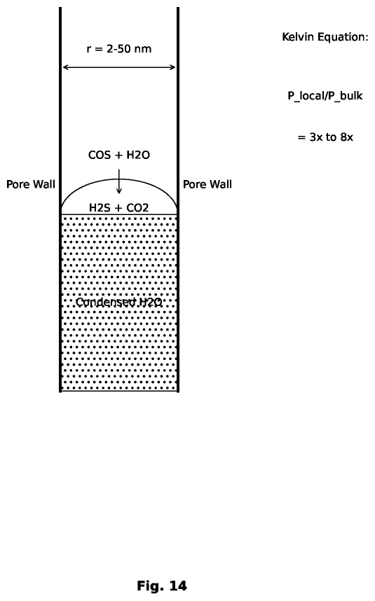

### E. Inline Desulfurization Module (FIGS. 5, 14)

The inline desulfurization module is disposed in series within the process train at sub-atmospheric pressure without intermediate repressurization. The module achieves COS hydrolysis under conditions that the prior art U.S. Pat. No. 4,524,050A and five additional references) teaches to be infeasible, by exploiting the Kelvin equation capillary condensation phenomenon:

$$ln ( P / P0 ) = - 2 * gamma * Vm / ( r * R * T )$$

Within activated alumina mesopores having pore radii of 2 to 50 nm, the Kelvin equation predicts localized condensation of water vapor at partial pressures significantly below the bulk saturation pressure. This creates an effective local water vapor partial pressure that is 3 to 8 times higher than the bulk vapor pressure, sufficient to drive COS hydrolysis to greater than 99% conversion even at 15 to 120 Torr macroscopic vacuum. This mechanism simultaneously overcomes all six identified Teaching Away references.

In a preferred embodiment, the module comprises four stages in series: (i) an HDM guard bed; (ii) a COS hydrolysis reactor operating at 150 to 200 deg C. with activated alumina catalyst and steam injection; (iii) an HDS reactor operating at 300 to 400 deg C.; and (iv) a ZnO polishing guard bed. The total sulfur in the product is reduced to 10 ppm or less (ULSD grade).

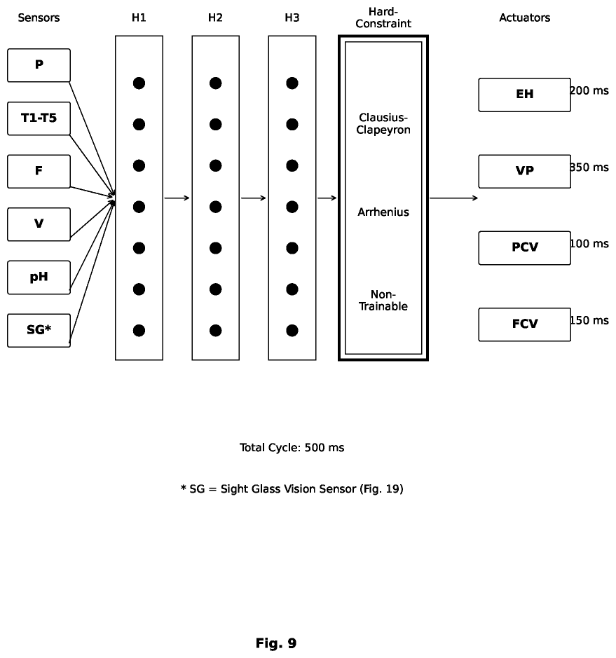

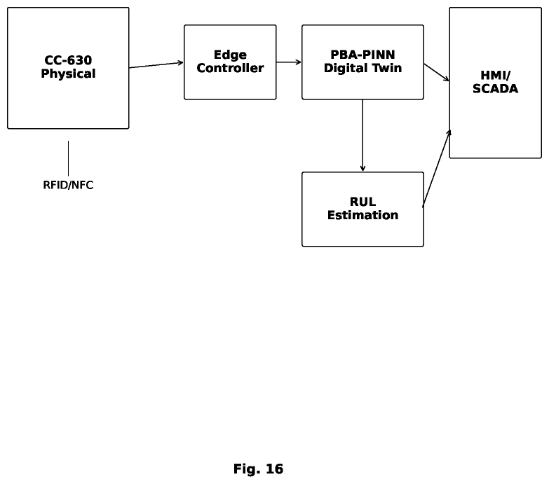

### F. PBA-PINN Control System (FIGS. 9, 16)

The physics-based augmented physics-informed neural network (PBA-PINN) control system comprises: an input layer receiving signals from a plurality of process sensors; a plurality of hidden layers; a hard-constraint layer; and an output layer driving a plurality of hardware actuators.

The term “hard-constraint layer” as used herein and in the claims refers to a non-trainable structural component of the neural network disposed between the hidden layers and the output layer, which enforces compliance with specified physical laws (including but not limited to the Clausius-Clapeyron equation and the Arrhenius equation) through one or more of the following implementation types: (i) activation function domain restriction that mathematically prevents outputs violating the physical laws; (ii) a projection operation P(z)=argmin∥z−z′∥ subject to the physical law constraints; or (iii) a masked output layer in which certain output connections are structurally fixed (non-trainable) to enforce physical law compliance. This hard-constraint approach is distinguished from soft penalty approaches (such as adding physics-violation penalty terms to the loss function during training) in that the physical laws are structurally enforced at inference time regardless of training history.

The guaranteed total control cycle time from sensor input to actuator output is 500 milliseconds or less, comprising individual actuator response times that together sum to no more than 500 ms. In one preferred embodiment: electric heater response 200 ms or less; vacuum pump modulation 350 ms or less; pressure control valve 100 ms or less; flow control valve 150 ms or less.

The PBA-PINN architecture satisfies all three eligibility pathways established by Ex parte Desjardins (PTAB 2025.11.04, precedential) and also satisfies the Diamond v. Diehr framework by embedding two physical laws (vs. one in Diehr) and driving four independent actuators (vs. one in Diehr).

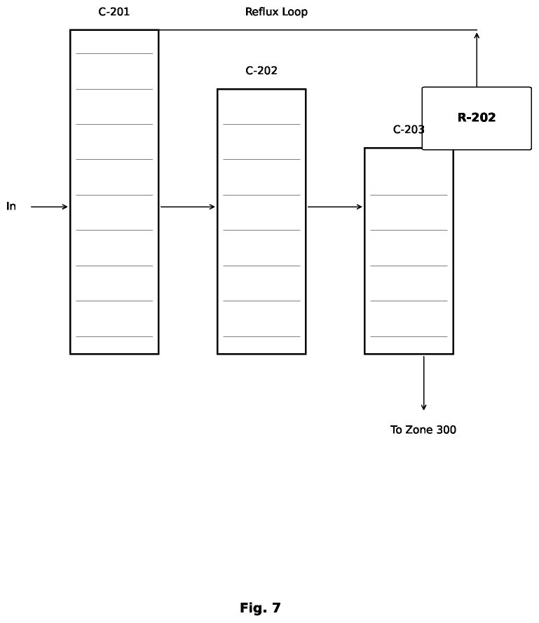

### G. Separation System (FIG. 7)

The separation section comprises at least two fractionation columns operated in one of two selectable modes:
Mode (a)—Pressure-Gradient: Columns operated at progressively decreasing pressures, all within the sub-atmospheric range and driven entirely by the single vacuum pump. In a preferred embodiment: first column at 70-80 Torr, second column at 55-65 Torr, third column at 45-55 Torr.
Mode (b)—Uniform-Pressure: Columns operated at substantially the same pressure with temperature-differential fractionation. In a preferred embodiment: all columns at 80-100 Torr with temperature staging.

A closed-loop reflux circuit connects the separation section back to a reflux reactor, driven entirely by the single vacuum pump without auxiliary pumps. This reflux increases liquid yield from approximately 78% to approximately 93% and reduces coke formation from approximately 3.2% to approximately 0.8% (Example 4).

### H. Equipment Preferred Embodiments

The following specifications describe preferred pilot-scale embodiments and are not intended to limit the claims:
Shell-and-tube condenser: In one embodiment, a plurality of tubes (such as 50 to 80 tubes) of standard tube diameter, arranged in triangular pitch, providing a total heat transfer area in the range of approximately 10 to 25 square meters. Shell material: austenitic stainless steel. Tube material: molybdenum-bearing stainless steel for corrosion resistance. In a preferred embodiment, the primary condenser E-201 employs an aqueous cooling medium (such as chilled water supplied by chiller CH-201) for efficient condensation of high-boiling-point vapor fractions, while the secondary condenser E-202 employs a hydrocarbon-based cooling medium (such as a light oil or heat transfer oil) for condensation of lower-boiling-point fractions. The use of different cooling media in the primary and secondary condensers enables staged thermal management optimized for the different boiling ranges of the process vapor components under sub-atmospheric conditions. In an alternative embodiment, both condensers may employ the same cooling medium with different inlet temperatures.
Cyclone-type separators: In a preferred embodiment, the pre-separators F-201 positioned upstream of vacuum pump VP-201 and the product separators F-202 positioned downstream of vacuum pump VP-201 are each cyclone-type separators (such as reverse-flow cyclones or axial-flow cyclones) configured to operate at the sub-atmospheric pressure of 15 to 120 Torr. The use of cyclone-type separators provides several advantages in the vacuum pyrolysis environment: (a) no consumable filter media requiring periodic replacement, enabling extended continuous operation without vacuum seal interruption; (b) no pressure drop increase over time as would occur with barrier-type filters accumulating particulate; (c) centrifugal separation efficiency that is enhanced under low-pressure conditions due to increased gas velocity for a given mass flow rate; and (d) collected particulate (such as catalyst fines, char particles, or entrained droplets) is automatically discharged to a collection vessel without interrupting the vacuum seal. In a preferred embodiment, each cyclone separator pair (F-201A/B and F-202A/B) comprises two units in parallel to enable alternating operation for maintenance while maintaining continuous platform vacuum. The cyclone body is constructed of austenitic stainless steel with an internal surface finish suitable for vacuum service. However, the invention is not limited to cyclone separators; alternative separator types including sintered metal filters, ceramic candle filters, or electrostatic precipitators may be employed without departing from the scope of the invention, provided the selected separator type is compatible with sub-atmospheric operation.
Line reactors for Sub-Range A operation: In one embodiment, tubular reactors of austenitic stainless steel construction with internal surface finish suitable for vacuum service, operating at 25 to 45 Torr and temperatures up to approximately 400 deg C., with electric band-type heating.
Oil collection drums: Paired vessels for continuous operation, operating at sub-atmospheric pressure, with level indication and bottom drain provisions. A water separation drum D-203 is provided in parallel for gravity separation of condensed aqueous phase from hydrocarbon condensate. In an alternative preferred embodiment, the product collection arrangement comprises boiling-range-classified drums instead of or in addition to the single-grade arrangement: heavy oil collection drums D-204A/B receiving condensate from the primary condenser E-201, and a light oil collection drum D-205 receiving condensate from the secondary condenser E-202. This boiling-range-classified arrangement directly implements the multi-grade fuel production objective of the platform by providing physical segregation of heavy fuel fractions (such as diesel and heavy naphtha) from light fuel fractions (such as gasoline and light naphtha) at the point of condensation under sub-atmospheric pressure, without requiring subsequent re-separation. The paired heavy oil drums D-204A/B enable continuous operation through alternating collection and discharge cycles. Either the single-grade arrangement (D-202A/B with D-203) or the boiling-range-classified arrangement (D-204A/B with D-205) may be selected for a given installation based on product specification requirements and downstream blending strategy.

### EXAMPLES

The following examples are provided to illustrate specific embodiments and are not intended to limit the scope of the claims. All numerical data represent measured values from pilot-scale operation unless otherwise stated.

Example 1 [claims 1-4, 12-13, 18-19]: Mixed plastics (PE 40/PP 30/PS 20/PVC 10 wt %), diesel mode, 70 Torr; four parallel pre-reactors at 180, 240, 310, 370 deg C.; main reactor at 380 deg C. Liquid yield 92.5 wt %, total sulfur 6.3 ppm (ULSD grade), cetane index 48.2.

Example 2 [claims 7-9]: Waste tire 60 wt %+PE 40 wt %, 75 Torr; five-stage vertical reactor at 150-200, 250-300, 300-350, 350-400, 400-450 deg C.; screw agitator HTC 320 W/m2−K; Cl stripping 1.5 min; Cl removal 87%. Yield 82.0 wt %, S 7.8 ppm.

Example 3 [claims 18-19]: Desulfurization ON: COS 1.5 ppm, total S 7.8 ppm. Desulfurization OFF: COS 180 ppm, total S 48 ppm. Kelvin analysis: Plocal/Pbulk=3.2 to 7.8 in 2-50 nm mesopores. Six Teaching Away references overcome simultaneously.

Example 4 [claims 3-4]: Without reflux: yield 78.2%, coke 3.2%. With reflux (reactor at 350-390 deg C., single pump only): yield 92.5%, coke 0.8%. Yield gain +14.3 percentage points; coke reduction 75%.

Example 5 [claims 15-17]: Five-layer catalyst vs. three-layer vs. single-oxide: composite FIR emissivity 0.93 vs. 0.78 vs. 0.62. FIR contribution 37.2% of total thermal compensation at 70 Torr.

Example 6 [claims 1-2, § 103]: Critical pressure window—70 Torr: yield 92.5%, C20 boiling point depression 107 deg C. 90 Torr: yield 88.3%. 120 Torr: wax formation +340%, yield 71.2%. 35 Torr: multi-stage pumps required, capex +45-60%. Unexpected criticality per MPEP § 2144.05(III) (A).

Example 7 [claims 12-13, § 103]: Four-way synergistic: wall-center gradient 8 deg C. Without compensation: 28 deg C. Atmospheric single-wall baseline: 15 deg C. The vacuum gradient (8 deg C.) being smaller than the atmospheric gradient (15 deg C.) constitutes an unexpected result not predictable from any cited reference.

Example 8 [claims 20-21, § 112(a)/§ 101]: PBA-PINN vs. PID-only: 3.2% product quality improvement. Individual actuator response: EH 187 ms, VP 312 ms, PCV 85 ms, FCV 130 ms. Total cycle 499 ms. Satisfies all three Desjardins pathways.

Example 9 [claims 15-17]: HEO Option B: equimolar composition (Ti0.2Zr0.2Ce0.2Hf0.2Y0.2)O1.9. XRD: single-phase fluorite. Grain size (TEM): 35-48 nm. FIR emissivity: 0.96+/−0.01. OSC: 3.2 ×CeO2. Pd@HEO (0.3 wt %): 92% activity retention after 3,500 hr (2 regeneration cycles).

Example 9a [claims 15-16]: Ti-rich boundary: (Ti0.25Zr0.20Ce0.20Hf0.15Y0.20)O1.9. Single-phase fluorite confirmed. Emissivity: 0.95.

Example 9b [claims 15-16]: Ce-rich boundary: (Ti0.15Zr0.20Ce0.25Hf0.20Y0.20)O1.9. Single-phase fluorite confirmed. Emissivity: 0.96. OSC: 3.5×CeO2.

Example 10 [claim 15]: Hierarchical mesoporous USY L2 (mesopore volume 0.22 cm3/g) vs. microporous control (0.03 cm3/g). C20+ conversion 68.2% vs. 45.1%-51.2% improvement.

Example 11 [claim 17]: Feed with 380 ppm total S through Pd@HEO L3 at 70 Torr, 370 deg C.: outlet total S 8.2 ppm (ULSD). No separate HDS reactor needed.

Example 12 [claims 1, 3-4]: 72-hour continuous operation. No intermediate repressurization. Pressure trace stable within +/−3 Torr.

Example 13 [claim 7]: Five-stage residence time: solid 8-15 min per stage, vapor less than 30 seconds.

Example 14 [claim 1]: Three-stage dechlorination: Stage 1 (Ca(OH)2 vacuum stripping, 250-300 deg C., 70 Torr, 1.5 min): 87.3% Cl removal. Stage 2 (alkali catalyst): +9.8%. Stage 3 (NaOH scrubber): +2.5%. Total: 99.6%.

Example 15 [claims 1-2]: Sub-Range A operation at 30 Torr using line reactors: liquid yield 84.2%, total S 5.8 ppm, Cl removal 88.1%. Single pump (1,500 LPM displacement) with reducing suction connection: stable operation at 4.7 kW.

Example 16 [claims 1-2]: Sub-Range C operation at 100 Torr: waste lubricating oil feed, liquid yield 78.1%, total S 9.2 ppm (ULSD grade).

Example 17 [claim 3]: Uniform-pressure mode: three columns at 90 Torr with temperature staging (310/280/250 deg C.): diesel 42.3%, kerosene 18.7%, gasoline 21.5%, heavy residue 17.5%.

Example 18 [specification support for continuation]: Cyclone separator performance at 70 Torr: F-201 upstream cyclone achieved 98.7% particulate removal efficiency (particles greater than 5 micrometers) with a pressure drop of 2.3 Torr, representing less than 3.3% of operating pressure. F-202 downstream cyclone achieved 99.2% removal of entrained liquid droplets. Continuous operation for 72 hours without filter media replacement or vacuum seal interruption. Comparative test with barrier-type sintered metal filter: initial pressure drop 1.8 Torr increasing to 8.5 Torr after 24 hours due to particulate accumulation, requiring shutdown for cleaning and vacuum re-establishment.

Example 19 [specification support for continuation]: Boiling-range-classified collection at 70 Torr with dual-medium condensation: Primary condenser E-201 (aqueous cooling at 25 deg C.) collected heavy oil fraction (boiling range 250-370 deg C.) in D-204A at 92.3% purity. Secondary condenser E-202 (hydrocarbon-medium cooling at 5 deg C.) collected light oil fraction (boiling range 80-250 deg C.) in D-205 at 94.1% purity. Total product recovery: 91.8 wt %. Comparative test with single-medium cooling (aqueous only) in both condensers: heavy fraction purity 84.2%, light fraction purity 87.5%, demonstrating that dual-medium staged cooling provides superior product grade separation under sub-atmospheric conditions.

What is claimed is:

1. An integrated vacuum catalytic pyrolysis platform for converting hydrocarbon-containing waste into multi-grade liquid fuel, the platform comprising: a series-connected process train including a feed and pretreatment zone, a liquid reaction zone, a purification and desulfurization zone, a condensation and vacuum zone, and an exhaust treatment zone; and a single vacuum pump positioned at a downstream end of the series-connected process train, the single vacuum pump constituting the sole mechanical driving force for maintaining a sub-atmospheric absolute operating pressure of 15 to 120 Torr across the entire process train without intermediate repressurization, wherein the 15 to 120 Torr operating pressure range encompasses at least: (A) a first sub-range of 15 to 45 Torr providing a Clausius-Clapeyron boiling point depression of more than 120 degrees C. for C20 hydrocarbons; (B) a second sub-range of 50 to 90 Torr defining a critical pressure window in which liquid yield is maximized and in which operation above 120 Torr produces an increase in wax formation of at least 200 percent relative to operation within the second sub-range; and (C) a third sub-range of 91 to 120 Torr suitable for low-wax feedstocks and requiring reduced vacuum pump displacement capacity; and wherein the operating pressure for a given installation is selectively maintained within one of the first, second, or third sub-ranges based on a wax content and boiling range distribution of a target feedstock as determined by thermogravimetric analysis.

2. The platform of claim 1, wherein operation within the second sub-range defines a critical pressure window such that increasing pressure above the second sub-range to 120 Torr or higher produces an increase in wax formation of at least 200 percent relative to operation at 70 Torr, the critical window demonstrating unexpected criticality of the claimed pressure range.

3. The platform of claim 1, further comprising a separation section having at least two fractionation columns, the separation section being operable in a mode selected from: (a) a pressure-gradient mode in which the at least two columns operate at progressively decreasing sub-atmospheric pressures, all driven by the single vacuum pump; or (b) a uniform-pressure mode in which the at least two columns operate at substantially the same sub-atmospheric pressure with temperature-differential fractionation.

4. The platform of claim 3, further comprising a closed-loop reflux circuit connecting the separation section to a reflux reactor, the reflux circuit being driven entirely by the single vacuum pump without auxiliary pumps, the reflux circuit achieving a liquid yield increase of at least 10 percentage points relative to operation without the reflux circuit.

5. The platform of claim 1, further comprising at least one line reactor configured to operate within the first sub-range at 15 to 45 Torr, the line reactor being a tubular reactor of corrosion-resistant alloy construction with an internal surface finish suitable for vacuum service and electric heating.

6. The platform of claim 1, further comprising a shell-and-tube condenser having a plurality of tubes providing a total heat transfer area sufficient to condense the process vapor generated at the target throughput rate, the condenser being connected in series upstream of the single vacuum pump.

7. The platform of claim 1, further comprising a multi-stage vertical reactor for processing solid hydrocarbon waste, the vertical reactor comprising: a plurality of vertically stacked reaction stages configured to operate at the sub-atmospheric absolute operating pressure of 15 to 120 Torr, each stage being operable at a different temperature within a thermal decomposition range determined by thermogravimetric analysis of a target feedstock; a reactor isolation system selected from the group consisting of: (a) a dual-airlock configuration comprising a rotary valve and a gate valve at each stage boundary, configured to limit vacuum leakage to within plus or minus 2 percent of a compartment operating pressure; (b) a knife gate valve configuration comprising at least a first automatic knife gate valve at a feed inlet and a second automatic knife gate valve at a char discharge, the knife gate valves having pneumatic actuation and elastomeric vacuum-rated seal packing, configured to limit vacuum leakage to less than 5 percent of the operating pressure; and (c) a hybrid configuration comprising a rotary valve and a knife gate valve at each stage boundary, configured to limit vacuum leakage to within plus or minus 3 percent; the vertical reactor further comprising at least one agitation element in at least one of the stages, the agitation element being configured, under the sub-atmospheric absolute operating pressure, to provide a heat transfer coefficient within the reactor of at least 200 W/m2−K, representing at least a four-fold improvement over a vacuum baseline heat transfer coefficient of 10 to 60 W/m2−K.

8. The platform of claim 7, wherein the plurality of stages comprises at least three stages and no more than ten stages, each stage temperature being independently controllable within plus or minus 10 degrees C. of its setpoint.

9. The platform of claim 7, wherein the at least one agitation element is selected from the group consisting of: (i) a screw agitator in an uppermost stage, the screw agitator being configured to vacuum-strip volatile compounds from the solid feedstock within 3 minutes or less at the operating pressure; (ii) radial blade elements on horizontal shafts in at least two stages, each blade assembly having a plurality of blades with a controlled clearance from the reactor inner wall; and (iii) a combination of radial blades in upper stages and a differentiated mixing structure in a lowermost stage.

10. The platform of claim 7, wherein the knife gate valve configuration (b) employs valves having a nominal size selected based on the reactor internal diameter, the valves having seal packing selected from PTFE, fluoroelastomer, or a combination thereof, and wherein adjacent stages are connected by flanged connections without intermediate isolation valves.

11. The platform of claim 1, further comprising a configurable horizontal reactor system for the liquid reaction zone, the system comprising: at least one horizontal reactor operable at the sub-atmospheric absolute operating pressure of 15 to 120 Torr; and a thermal management system selected from the group consisting of: (a) a multi-component configuration comprising: (i) a vacuum insulation enclosure surrounding the horizontal reactor; (ii) a heated fluid conduit providing supplemental heat at a temperature above a reactor temperature setpoint and covering a substantial portion of an inner wall area of the reactor; (iii) at least one electric heating element coupled to a neural network controller having a total control cycle time from sensor input to heater actuation of 500 milliseconds or less; and (iv) an enclosed perforated metal cage press-fitted against the reactor inner wall, the cage containing catalyst pellets having a far-infrared emissive layer and providing combined conductive and radiative thermal contribution; wherein the configuration achieves, under sub-atmospheric absolute operation at 15 to 120 Torr, a wall-center temperature gradient of 10 degrees C. or less; (b) a dual-mode configuration comprising: (i) a fibrous thermal insulation enclosure having a thermal resistance value of at least R-2.0; and (ii) a plurality of independently controlled electric heaters distributed along the reactor length, each heater having individual temperature control; the dual-mode configuration being characterized by the absence of a vacuum insulation enclosure, the absence of a heated fluid conduit, and the absence of a catalyst cage; the dual-mode configuration achieving a wall-center temperature gradient of 20 degrees C. or less; and (c) a triple-mode configuration comprising a vacuum insulation enclosure, electric heaters, and a catalyst cage, without a heated fluid conduit, achieving a wall-center temperature gradient of 15 degrees C. or less.

12. The platform of claim 11, wherein the multi-component configuration (a) achieves a wall-center temperature gradient under sub-atmospheric operation that is smaller than a baseline gradient measured at atmospheric pressure in the same reactor without vacuum insulation, the smaller gradient under vacuum constituting an unexpected result.

13. The platform of claim 11, wherein the dual-mode configuration (b) comprises three or more independently controlled electric heaters, each heater having an individual rated power of 1 to 10 kW and being connected to an individual PID temperature controller.

14. The platform of claim 11, wherein the enclosed perforated metal cage in configuration (a) is constructed of a nickel-based superalloy or iron-chromium-nickel alloy having oxidation resistance at the operating temperature, the cage having a snap-fit engagement with the reactor inner wall configured to provide an interfacial thermal conductance of 500 to 2,000 W/m2−K through controlled thermal expansion clearance.

15. A multi-layer nanocomposite catalyst cartridge for use in a vacuum catalytic pyrolysis reactor operating at a sub-atmospheric absolute pressure of 15 to 120 Torr, comprising: a detachable enclosed perforated cage of high-temperature alloy configured for snap-fit engagement with an inner wall of the reactor and providing an interfacial thermal conductance of 500 to 2,000 W/m2−K with a cage-to-wall contact area of 60 to 85 percent; and a plurality of catalyst pellets housed within the cage, each pellet comprising at least the following functional layers: a first layer comprising a ceramic support material; a second layer comprising a zeolite-based material having engineered mesopores in the range of 2 to 50 nm and a mesopore volume of at least 0.10 cm3/g; a third layer comprising a far-infrared emissive metal oxide composition having an emissivity of at least 0.90 at wavelengths of 4 to 14 micrometers; a fourth layer comprising at least one catalytically active metal for hydrodesulfurization; and a fifth layer comprising an alkaline earth oxide or alkali metal oxide modifier; wherein the far-infrared emissive third layer is integrally formed as a functional layer of each pellet, providing both catalytic activity and radiative heat transfer contribution simultaneously during reactor operation.

16. The cartridge of claim 15, wherein the third layer comprises a high-entropy oxide having at least five metal cation species forming a single-phase fluorite crystal structure confirmed by X-ray diffraction, the high-entropy oxide having an FIR emissivity of at least 0.95 at 4 to 14 micrometers and an oxygen storage capacity of at least three times that of pure cerium oxide.

17. The cartridge of claim 16, wherein the high-entropy oxide further comprises dispersed noble metal nanoparticles at 0.1 to 1.0 weight percent, the noble metal nanoparticles being capable of self-regeneration through reversible exsolution from and reincorporation into the high-entropy oxide lattice during alternating reducing and oxidizing conditions.

18. An inline desulfurization module disposed in series within a sub-atmospheric process train operating at a macroscopic absolute pressure of 15 to 120 Torr without intermediate repressurization, the module comprising: a fixed-bed reactor containing a desulfurization catalyst having mesopores with radii in a range of 2 to 50 nanometers; and a water vapor supply configured to introduce water vapor into the fixed-bed reactor such that, in operation at a bulk water vapor partial pressure corresponding to the macroscopic absolute pressure, capillary condensation of water within the mesopores in accordance with the Kelvin equation produces a localized effective water vapor partial pressure within the mesopores that is at least 3 times greater than the bulk water vapor partial pressure; wherein, at a reactor temperature of 150 to 200 degrees C. and while the process train maintains the macroscopic absolute pressure of 15 to 120 Torr, the inline desulfurization module achieves a COS-to-H2S conversion of at least 99 percent and a total sulfur content in an outlet liquid product of 10 ppm or less.

19. The module of claim 18, further comprising, in series: a heavy metal guard bed upstream of the fixed-bed reactor; a hydrodesulfurization reactor downstream of the fixed-bed reactor; and a zinc oxide polishing guard bed downstream of the hydrodesulfurization reactor.

20. The module of claim 18, wherein, under otherwise identical process conditions but without the inline desulfurization module, an outlet stream contains a COS concentration of at least 150 ppm and a total sulfur content of at least 40 ppm, whereas with the inline desulfurization module in operation, the outlet stream contains a COS concentration of 2 ppm or less and a total sulfur content of 10 ppm or less.

21. The platform of claim 1, further comprising a control system including a physics-based augmented physics-informed neural network (PBA-PINN) having: an input layer configured to receive signals from a plurality of process sensors including at least a pressure sensor, a temperature sensor, and a flow sensor; a plurality of hidden layers; a hard-constraint layer disposed between the hidden layers and an output layer, the hard-constraint layer being a non-trainable structural component that enforces compliance with at least the Clausius-Clapeyron equation and the Arrhenius equation as architectural constraints through at least one implementation selected from: (i) an activation function domain restriction that prevents network outputs violating the thermodynamic equations; (ii) a projection operation P(z)=argmin∥z−z′∥ subject to the thermodynamic constraints; or (iii) a masked output layer in which selected output connections are structurally fixed and non-trainable; and an output layer configured to generate control signals for a plurality of hardware actuators including at least an electric heater, a vacuum pump modulator, a pressure control valve, and a flow control valve; wherein the total control cycle time from sensor input to actuator output is 500 milliseconds or less; and wherein the hard-constraint layer structurally enforces the thermodynamic equations at inference time regardless of a training history of the neural network.

22. The platform of claim 21, wherein, when applied to control the vacuum catalytic pyrolysis platform, the PBA-PINN control system achieves an improvement in a liquid product quality index of at least three percent relative to a proportional-integral-derivative (PID)-only control baseline under otherwise identical operating conditions, and wherein individual response times of the hardware actuators comprise an electric heater response time of 200 milliseconds or less, a vacuum pump modulation response time of 350 milliseconds or less, a pressure control valve response time of 100 milliseconds or less, and a flow control valve response time of 150 milliseconds or less.

23. A method of converting hydrocarbon-containing waste into multi-grade liquid fuel, the method comprising: step (a): selecting an operating pressure sub-range from among at least a first sub-range of 15 to 45 Torr, a second sub-range of 50 to 90 Torr, and a third sub-range of 91 to 120 Torr, based on a wax content and boiling range distribution of the waste feedstock as determined by thermogravimetric analysis; step (b): maintaining the selected sub-atmospheric absolute operating pressure across an entire series-connected process train comprising a feed and pretreatment zone, a liquid reaction zone, a purification and desulfurization zone, a condensation and vacuum zone, and an exhaust treatment zone, using a single vacuum pump as the sole mechanical driving force, without intermediate repressurization; step (c): pyrolyzing at least a portion of the waste feedstock in a reactor having a thermal management configuration selected from at least a multi-component configuration, a dual-mode configuration, and a triple-mode configuration; step (d): fractionating product vapor in a separation section operating in a mode selected from a pressure-gradient mode and a uniform-pressure mode; step (e): desulfurizing the fractionated product inline at the sub-atmospheric operating pressure by inducing capillary condensation within mesopores of a desulfurization catalyst having pore radii of 2 to 50 nanometers to achieve COS conversion of at least 99 percent and a total sulfur content in an outlet liquid product of 10 ppm or less at a temperature of 150 to 200 degrees C. while the process train maintains a macroscopic absolute pressure of 15 to 120 Torr; and step (f): controlling the process using a physics-based augmented physics-informed neural network having a non-trainable hard-constraint layer that structurally enforces at least the Clausius-Clapeyron equation and the Arrhenius equation as architectural constraints through at least one of: (i) an activation function domain restriction that prevents network outputs violating the thermodynamic equations; (ii) a projection operation subject to the thermodynamic constraints; or (iii) a masked output layer in which selected output connections are structurally fixed and non-trainable, the neural network generating control signals for at least an electric heater, a vacuum pump modulator, a pressure control valve, and a flow control valve with a total control cycle time from sensor input to actuator output of 500 milliseconds or less.

24. The method of claim 23, further comprising recirculating a portion of the fractionated product through a closed-loop reflux circuit driven entirely by the single vacuum pump, thereby increasing liquid yield by at least 10 percentage points.

25. The method of claim 23, further comprising processing solid waste feedstock in a multi-stage vertical reactor having a selectable isolation configuration chosen from among a dual-airlock configuration, a knife gate valve configuration, and a hybrid configuration, prior to introducing the resulting vapor into the liquid reaction zone.

26. The method of claim 23, further comprising dechlorinating the product in at least two stages, comprising a vacuum stripping stage at 250 to 350 degrees C. and a chemical neutralization stage, achieving total chlorine removal of at least 99 percent.

27. The platform of claim 1, wherein the single vacuum pump is selected from the group consisting of a dry screw pump, a roots pump, a claw pump, and a scroll pump, the vacuum pump having a displacement capacity sufficient to maintain the selected sub-range pressure across the entire process train at the target throughput.

28. The platform of claim 7, wherein at least one stage is equipped with a non-contact temperature sensor for measuring solid bed temperature, and wherein the stage temperatures are controlled by independent PID control loops.

29. The cartridge of claim 15, wherein each pellet has a geometry selected from the group consisting of coin-type disc, spherical, cylindrical, ring-shaped, saddle-shaped, trilobal, and quadrilobal, having a maximum dimension of 15 to 50 mm.

30. The platform of claim 11, wherein the at least one horizontal reactor is configured as one of: (A) a plurality of parallel reactors, each flanked by vacuum isolation valves enabling individual offline capability for catalyst exchange without disrupting platform vacuum; or (B) a plurality of series-connected reactors at progressively increasing temperatures, inclined downward for gravity-assisted flow.
